(19) United States
(12) Patent Application Publication
(10) Pub. No.: US 2014/0296349 A1
(43) Pub. Date: Oct. 2, 2014

(54) ANTIMICROBIAL CLEANING COMPOSITION

(71) Applicant: BASF SE, LUDWIGSHAFEN (DE)

(72) Inventors: Sabine Both, Neuss (DE); Christian Muckenschnabel, Dormagen (DE); Menno Hazenkamp, Riehen (CH)

(73) Assignee: BASF SE, LUDWIGSHAFEN (DE)

(21) Appl. No.: 14/345,987

(22) PCT Filed: Sep. 20, 2012
(86) PCT No.: PCT/EP2012/068528

§ 371 Date: Mar. 20, 2014

Related U.S. Application Data
(60) Provisional application No. 61/541,155, filed on Sep. 30, 2011.

(30) Foreign Application Priority Data
Sep. 30, 2011 (EP) 11183580.7

(51) Int. Cl. A01N 31/16; A01N 25/30

(52) U.S. Cl. CPC A01N 31/16; A01N 25/30
USPC 514/721

(57) ABSTRACT

The present invention relates to an antimicrobial cleaning composition comprising at least one sugar surfactant and a compound of the formula (I) as biocide, and to the use of the sugar surfactants for improving the activity of the biocide.

The present invention relates to an antimicrobial cleaning composition comprising at least one sugar surfactant and a compound of the formula (I) as biocide, and to the use of the sugar surfactant for improving the activity of the biocide.

Hard surface cleaning and disinfecting compositions generally comprise one or more surfactants and optionally one or more biocide(s). Mostly anionic, nonionic, amphoteric and/or cationic surfactants are used in such cleaning compositions. Nonionic surfactants are usually used on account of their effectiveness against fatty soiling. Nonionic surfactants exhibit low or no biocidal effect, it being observed that in general the biocidal effect of surfactants is low.

Consequently, it is customary to add a separate biocide to the compositions. Typical biocides are strong acids, alkali, phenolic substances and oxidizing agents, such as peracids and hypohalites. These biocides are generally highly reactive species. As a result, they exhibit toxic, corrosive and irritative properties. In addition, their activity as biocide is short-lived on account of their high reactivity. Consequently, these reactive components are required in relatively high proportions in the cleaning compositions.

DE69722408T2 reports on a synergy with regard to antimicrobial effectiveness between aromatic alcohols or phenols which are different from phenol per se and nonionic ethoxylated alkanol surfactants, outside of the physiological pH range. However, an increase in the detergency is not disclosed.

The prior art discloses further surfactants which increase the effects of certain biocides. In DE 3619375 it has been found that the use of alkyl glycosides as in alcohol- or carboxylic-acid-containing antiseptic compositions, leads to a significant increase in the bactericidal effect of the alcohols or carboxylic acids. This is evident from an improvement in the microbicidal effect towards Gram-positive bacteria. These compositions are used at a strongly acidic pH, in general below pH 3. However, discussion here is not of improved cleaning, but improved effect of the biocide.

DE60210317T2 describes an antimicrobial composition for treating a surface which comprises a polymeric biguanide as biocide. These aqueous compositions show a good filming/streaking and shine retention/enhancement profile coupled with biocidal effect. Improved cleaning is not disclosed.

The person skilled in the art knows that the nonpolar biocides reduce the detergency. Further surfactant/biocide combinations are also known, which exhibit a reduced effect compared with the biocide by itself. In theory, this is explained by micelles of the surfactant into which the biocide is absorbed and therefore contributes les to the effect (“Surface Active Agents”, Porter 1990, Elsevier).

The use of hydroxydiphenyl ethers as microbicidal active ingredient constituents in household cleaners is known e.g. from EP 1 167 503 A1. However, reference is made here to the fact that these cleaners have a high content of synthetic detergents or soaps which considerably reduce the bactericidal effect of the hydroxydiphenyl ether in the formulation. As a result, the bactericidal activity of such household cleaners is unsatisfactory.

It was an object of the present invention to provide novel improved antimicrobial cleaning compositions which exhibit in particular an improved primary and/or secondary detergency. Moreover, the antimicrobial effect should remain constant and/or be improved at the same time.

This object is achieved by the antimicrobial cleaning composition according to the invention.

The present invention therefore provides an antimicrobial cleaning composition comprising at least one sugar surfactant and a compound of the formula (I) as biocide

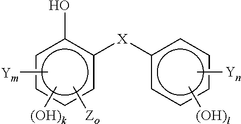

where the indices have the following meaning:

### X=O, S or —CH2—,

### Y=Cl or Br,

Z=SO2H, NO2 or C1C4-alkyl,
k, l=0 or 1,
m=0, 1, 2 or 3,
n=0, 1, 2 or 3,
o=0 or 1.

Within the context of the present invention, sugar surfactants are nonionic surfactants with a carbohydrate as hydrophilic moiety and fatty alcohols or fatty acids as hydrophobic component.

In one embodiment of the present invention, a sugar surfactant of the general formula (II)

R—O—Gₚ

where R=alkyl or alkenyl,
G=aldose or ketose and
P=1, 2, 3, 4, 5, 6, 7, 8, 9 or 10, is used.

In a further variant, the sugar surfactants to be used according to the invention are alkyl and/or alkenyl polyglycosides of the formula II in which R is an alkyl and/or alkenyl radical having 4 to 22 carbon atoms, G is a sugar radical having 5 or 6 carbon atoms and P is numbers from 1 to 10. In a further embodiment, the alkyl and/or alkenyl polyglycosides are derived from aldoses or ketoses having 5 or 6 carbon atoms.

The component G in formula (II) is selected in one embodiment from the group of hexoses, preferably from the group comprising allose, altrose, glucose, mannose, gulose, idose, galactose, talose, psicose, fructose, sorbose, tagatose, particularly preferably glucose.

In a further embodiment, the component G in formula (II) is selected from the group of pentoses, preferably the group comprising ribulose, xylulose, ribose, arabinose, xylose, lyxose, particularly preferably xylose and/or arabinose.

In one variant of the invention, the preferred alkyl and/or alkenyl oligoglycosides are alkyl and/or alkenyl oligoglucosides.

The index number p in the general formula (I) gives the degree of oligomerization (DP), i.e. the distribution of mono- and oligoglycosides, and is a number between 1 and 10. Whereas p in a given compound must always be an integer and here in particular can assume the values p=1 to 6, the value p for a certain alkyl (oligo)glycoside is an analytically determined calculated parameter which in most cases is a fraction. In one embodiment of the invention, alkyl and/or alkenyl oligoglycosides with an average degree of polymerization p of from 1.1 to 3.0 are used.

The alkyl and/or alkenyl polyglycosides according to the invention can be obtained by the relevant methods of preparative organic chemistry. By way of representation of the extensive literature, reference may be made here to the review paper by Biermann et al. in Starch/Stärke 45, 281 (1993), and also J. Kahre et al. in SÖFW-Journal volume 8, 598 (1995).

As well as alkyl and/or alkenyl polyglycosides based on unbranched fatty alcohols, in one variant, alkyl and/or alkenyl polyglycosides with branched radicals R are used. In one embodiment, the radical R in formula (II) is selected from the group of alcohols comprising fatty alcohols, primary alcohols, in particular so-called oxo alcohols, for example nonyl, undecyl or tridecyl alcohols, and primary alcohols, which comprise linear octyl, decyl, dodecyl, tetradecyl, hexadecyl or octadecyl groups, and mixtures thereof.

In one variant, alcohols with a carbon chain, which may also be branched, having C4-C18, preferably C12-C16, in particular C12-C14, are selected.

In one embodiment of the invention, the branched radicals are isoamyl, isohexyl and/or isoheptyl, preferably 2-ethylhexyl and/or 2-propylheptyl.

According to the invention, it is also possible to use mixtures of different compounds of the general formula (II). Thus, all combinations of the various aldoses or ketoses with all possible alkyl- and/or alkenyl radicals can be used.

In a further embodiment, the cleaning composition according to the invention comprises, as biocide, a compound of the formula (Ia)

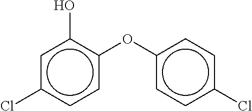

or the formula (Ib),

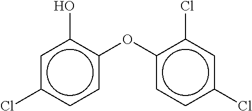

preferably (Ia).

According to the invention, it is also possible to use mixtures of different compounds of the general formula (I). Thus, it is possible to use all combinations of the various compounds of the general formula (II) with the various compounds of the general formula (I) in the compositions according to the invention, but also combinations of mixtures of the various compounds of the general formula (II) with the mixtures of the various compounds of the general formula (I).

Within the context of the invention, cleaning compositions or cleaners are:
compositions for cleaning and/or disinfecting hard surfaces, such as all-purpose cleaners, floor cleaners, dishwashing detergents for manual or automatic dishwashing, hand washes, glass cleaners, kitchen cleaners, bath and sanitary cleaners, WC cleaners, disinfectant cleaners,
cleaning and care compositions for textiles and laundry such as detergents, fabric softeners, stain removers.

Formulation types of the cleaners are selected from the group comprising: cleaner and disinfectant concentrate, liquid cleaners or disinfectants, pulverulent cleaners or disinfectants, sprays for cleaning or disinfection, emulsions and gels.

The surfaces to be treated are selected from the group comprising: glass, plastics, metal, steel, wood, stone materials, ceramic, cement, coatings, composite materials, textiles (natural fibers such as e.g. cotton, wool, silk and synthetic fibers such as polyester, polyolefins (PE, PP etc.), polyamide, polyurethane, PVC etc.), foam materials and upholstery materials and carpets.

In one variant of the present invention, it is a cleaning composition for hard surfaces. Within the context of the invention, hard surfaces are e.g. tiles, ceramic, glass, glass fibers, metals, steel, aluminum, plastic, wood, stone materials, coatings, composite materials, cement and the like, but no textiles.

During the cleaning of hard surfaces, it is often necessary to disinfect a surface. In this application, disinfection is understood as meaning the killing of microorganisms or the reduction in the growth of microorganisms.

In a further embodiment of the invention, the composition has a pH between 5 and 12, preferably 7 to 10, in particular 7 to 9.

In one variant, the composition according to the invention is in the form of a concentrate. The concentrates are usually aqueous preparations with an increased active substance content which is adjusted to the particular concentration corresponding to the application by means of dilution (in most cases with water). The concentrates preferably additionally comprise antioxidants such as e.g. BHT, ascorbic acid etc. as stabilizers.

In a further embodiment, the cleaning composition according to the invention comprises the compound of the formula (I) in an end concentration of from 0.0001 to 10%, preferably 0.0001 to 1%, in particular 0.003 to 0.5% by weight and the compound of the formula (II) in an end concentration of from 0.1 to 20%, preferably 1 to 10%, particularly preferably 2 to 5%, in particular 2.5 percent by weight.

In one embodiment of the invention, for cleaning and disinfection, the compound of the formula (I) is used in an end concentration of from 0.0001 to 10%, preferably 0.0001 to 1%, in particular 0.003 to 0.5% percent by weight.

In one embodiment of the invention, for cleaning, the compound of the formula (II) is used in an end concentration of from 0.1 to 20%, preferably 1 to 10%, particularly preferably 2 to 5%, in particular 2.5 percent by weight.

If concentrates are present, these are diluted such that, upon application to the surface to be cleaned, the compounds of the formula (I) and (II) are present in the aforementioned concentrations.

In one variant, the cleaning composition according to the invention comprises at least one further additive selected from the group comprising: stabilizers, antioxidants, further surfactants, acids, bases, hydrotropes, bleaching systems, consistency regulators, preservatives, dispersants, fragrances, dyes, complexing agents, solvents and water.

The present invention further provides a process for producing the antimicrobial cleaning composition according to the invention. The production takes place in working steps known to the person skilled in the art by mixing the ingredients, where the biocide of the formula (I) is firstly pre-dissolved in the sugar surfactant and is then brought into an aqueous phase.

The invention also further provides the use of a biocide of the formula (I) for increasing the detergency of nonionic sugar surfactants. In this connection, in particular the primary detergency is improved compared to a control without the biocide according to the invention.

Within the context of the present invention, primary detergency is to be understood as meaning the removal of dirt from a surface, preferably from a hard surface. In order to measure the primary detergency, in one variant of the invention, the IPP-Gardner test for all-purpose cleaners is used in accordance with “IPP standard” (SÖFW, No. 10/986, page 371).

The present invention thus relates to a method for improving the primary detergency of a cleaner comprising nonionic sugar surfactants by adding a biocide of the formula (I) compared to a control without this biocide measured using the IPP-Gardner test for all-purpose cleaners in accordance with “IPP standard” (SÖFW, No. 101986, page 371) or a variant thereof.

The primary detergency is increased according to the invention by 2%, 3%, preferably 4%, 5%, 6%, particularly preferably 7%, 8%, 9%, in particular 10% or more.

In one embodiment, the present invention provides a method for increasing the antimicrobial effect of a cleaning composition comprising nonionic sugar surfactants by adding a biocide of the formula (I).

As well as the improvement in the primary detergency, the use of the biocide of the formula (I) in a cleaning composition comprising nonionic sugar surfactants leads to the retention or improvement of the secondary detergency.

In one embodiment of the invention, the secondary detergency is the shine retention of the cleaned surface.

In one variant of the invention, the shine behavior is determined using the following test: before applying the test substance, a black ceramic tile is washed in a dishwasher with the 55° C. program “Universal Plus” and standard dishwasher powder and, after drying, cleaned with isopropanol and then with ethyl acetate. The surface is cleaned under warm water with a sponge and then cleaned again with distilled water and sponge. The run-off of the distilled water is assessed visually.

The light reflection is determined at a 20° angle on 5 points of the tile prepared in this way using a Byk-Gardner shine meter. 25 drops of test substance are applied using a pipette in 5 rows each with 5 drops and spread using a paper towel. Spreading takes place by wiping without pressure in 10 rows from top to bottom and 10 from bottom to top.

The test substance e.g. is applied in the following solution:

0.1% AS (active substance) test material, 1.0% AS Lutensol ON 80 (BASF), ad 100% demin. water

After drying, the light reflection is determined again, if possible, at the same points of the tile.

The shine retention arises from the ratio of the measurement value of the treated surface to the value of the cleaned tile before applying the test substance.

In one variant of the invention, the shine retention of the cleaning composition according to the invention is constant compared to the value of a cleaning composition without the biocide according to the invention, preferably increased by 2%, 3%, 4%, 5%, 6%, particularly preferably 7%, 8%, 9%, in particular 10% or more.

In one embodiment of the invention, the secondary detergency is the material compatibility.

In one variant of the invention, the material compatibility is determined using the following test:

by reference to the cracking on plastic rods following immersion in cleaning solutions, the determination serves to assess the compatibility of cleaners on plastics.

The plastic to be tested is provided with a metal pin, thereby placed under tension and immersed into the test solution.

After certain time intervals, the change in the plastic rod is assessed.

Depending on the objective, preference is given to using 5% AS (active substance) of the substances to be tested.

The evaluation takes place visually by reference to the following evaluation criteria: 1=unchanged, 2=cracks, 3=crack right through and 4=break.

In one variant of the invention the material compatibility of the cleaning composition according to the invention is constant compared to the value of a cleaning composition without the biocide according to the invention.

In conventional cleaners, the detergency is proportional to the emulsifying power of the formulation. However, the cleaning composition according to the invention exhibits an improved primary detergency as a result of the addition of the biocide for the same emulsifying power

In one embodiment of the invention, the secondary detergency is the emulsifying power. In one variant of the invention, the emulsifying power is determined using the following test:

Test solutions of defined concentration are covered with olive oil in a beaker and stirred under defined conditions. The emulsions produced in this way are then transferred to measuring cylinders. As a measure of the emulsion stability, the volume of separated aqueous phase after one hour and after four hours is determined.

The measurement series is recorded as desired at a water hardness of 0° German hardness or 16° German hardness. Firstly, 50 g of aqueous homogeneous surfactant solution with a mass fraction of w=2% active substance are prepared in a 400 ml beaker and/or in the case of formulations according to the particular requirement. The freshly prepared solution is then covered with 50 g of oil. The solutions are then stirred at a temperature of 20-25° C. at 1200 rpm±3 rpm for exactly 2 minutes. In this connection, the stirring element should be positioned at the height of the phase boundary. The emulsion is then transferred to a 250 ml measuring cylinder and the volume of the water which has separated out is read off after one hour and after four hours. During the measurement, the measuring cylinder should remain still.

The measurement values ascertained by single determination are comparable within the measurement series and should be checked by entraining a standard such as e.g. sodium lauryl sulfate. Should the measurement of the standard be outside of the tolerance range, the measurement series should be repeated.

In order to be able to read off the phase boundary more sharply in the case of experiments with colorless oils, some water- or oil-soluble dye can be added to the test liquid.

In one variant of the invention, the emulsifying power of the cleaning composition according to the invention is constant compared to the value of a cleaning composition without the biocide according to the invention.

The invention further provides the use of sugar surfactants for increasing the antimicrobial effect of the biocide of the formula (I).

The invention further provides the use of a cleaning composition according to the invention for cleaning and/or disinfecting hard surfaces.

The antimicrobial cleaning composition according to the invention exhibits a good, long-lasting disinfection effect. In addition, the cleaning composition according to the invention exhibits improved primary detergency as well as a constant or improved secondary detergency.

The use according to the invention of a sugar surfactant and of a compound of the formula (I) as biocide leads to synergy effects, clearly resulting in an improved detergency and improved antimicrobial effect.

Within the context of the invention, an improvement, rise or increase in a property is determined compared with a control in which the component, the effect of which is tested, is not present. For carrying out these experiments, the person skilled in the art has recourse to his general specialist knowledge.

Synergistic effects within the context of the present invention are effects which arise only by combining the nonionic sugar surfactants according to the invention with the biocides according to the invention and, as a result, the effect of one of these components is increased compared to a control without this component.

### EXAMPLES

In the examples below, Tinosan HP 100 means a 30% strength solution of the biocide or compound of the formula la in 1,2-propylene glycol.

### 1. Improved Detergency:

The detergency was determined by means of the IPP-Gardner test for all-purpose cleaners in accordance with “IPP standard” (SÖFW, No. 10/986, page 371).

### Formulation According to the Invention

F3 (APC as ready to use):
2.5% Glucopon 425 N/HH (50%)
0.8% Citric acid (100%)
0.5% NaOH (50%)
0.8% Sodium bicarbonate (100%)
0-0.5% Tinosan HP 100

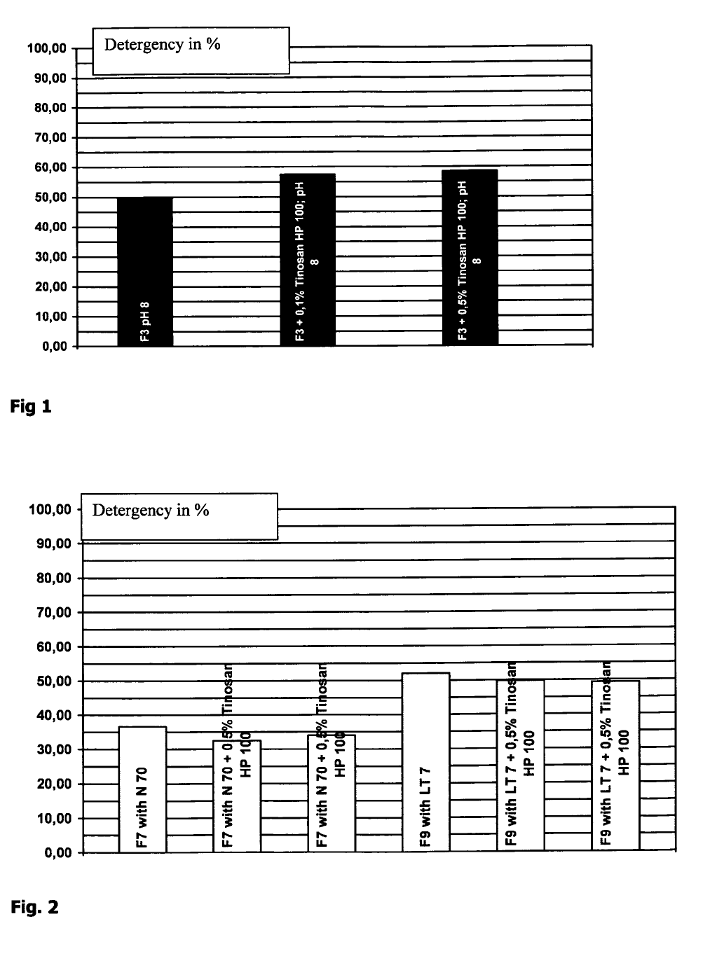

FIG. 1 shows the increase in the detergency of an all-purpose cleaner based on sugar surfactants (Glucopon).

### Comparison Formulations:

F7 (APC as ready to use):
2.5% Texapon N70
0.8% Citric acid (100%)
0.5% NaOH (50%)
0.8% Sodium bicarbonate (100%)
0-0.5% Tinosan HP 100

F9 (APC as ready to use):
2.5% Dehydol LT 7
0.8% Citric acid (100%)
0.5% NaOH (50%)
0.8% Sodium bicarbonate (100%)
0-0.5% Tinosan HP 100

FIG. 2 shows that only by adding the film-forming nonionic surfactant (Glucopon) is the primary detergency improved; upon adding a fatty alcohol ethoxylate (Dehydol LT 7), or the anionic surfactant (Texapon N70 lauryl ether sulfate), the detergency even deteriorates.

### 2. Shine Behavior:

The shine behavior was determined using the test described above:

| Formulation | Shine after treatment [%] |
|---|---|
| F3 pH 8 | 76.6% |
| F3 pH 9 | 78.2% |
| F3 + 0.1% Tinosan HP 100 pH 8 | 74.1% |
| F3 + 0.1% Tinosan HP 100 pH 9 | 84.8% |
| F3 + 0.5% Tinosan HP 100 pH 8 | 79.4% |
| F3 + 0.5% Tinosan HP 100 pH 9 | 78.4% |

Result: The shine behavior of the formulation remains unchanged and good as a result of adding the biocide according to the invention (Tinosan HP 100) and is even increased at higher concentrations or pH 9.

### 3. Material Compatibility:

The material compatibility was determined using the test described above:

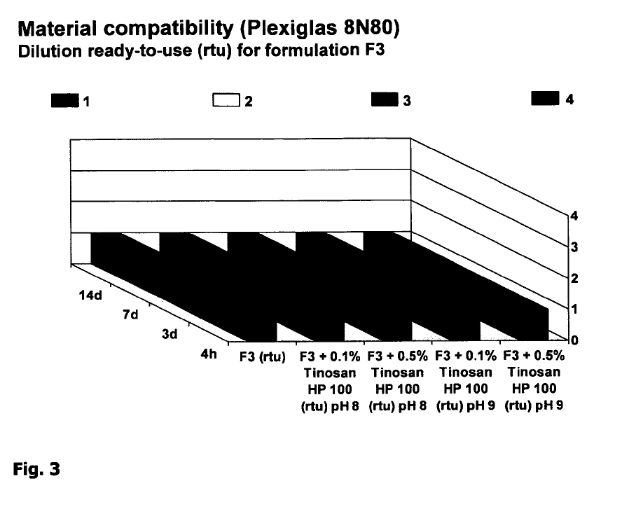

Results can be found in FIG. 3.

The addition of the nonpolar biocide does not adversely affect the material compatibility of the cleaning formulations on plastics.

### 4. Emulsifiability

The emulsifiability was determined using the test described above:

As a measure of the emulsion stability the volume of separated aqueous phase is determined after 1 hour and after 4 hours

| | Height of aqueous | Height of aqueous |
|---|---|---|
| | phase [ml] | phase [ml] |
| | 1 h | 4 h |
| F3 | 36 | 40 |
| F3 + 0.1% Tinosan HP 100 | 34 | 39 |
| F3 + 0.5% Tinosan HP 100 | 34 | 40 |

Result: By adding biocide, the emulsifiability of olive oil is not increased.

### 5. Antimicrobial Properties:

The antimicrobial, bactericidal activity of the cleaning composition according to the invention was determined on sponges and floor covering by means of a slightly modified US standard AATCC 100-2004.

The bacteriostatic activity was determined in accordance with CG standard 147e (agar diffusion test).

Cleaning compositions (all-purpose cleaners and hand dishwashing detergents) according to the invention containing 0-0.5% Tinosan HP 100 were used.

The germs used were pathogenic Gram-positive bacteria (Staphylococcus aureus ATCC 6538) and Gram-negative bacteria (Klebsiella pneumoniae ATCC 4352 and Salmonella choleraesuis ATCC 9184).

### Result:

The antimicrobial properties of the biocides of the formula 1a (Tinosan HP100) are retained. Both the germ-killing and also the long-lasting antimicrobial effect remained unchanged.

1. An antimicrobial cleaning composition comprising at least one sugar surfactant and a compound of the formula (I) as biocide 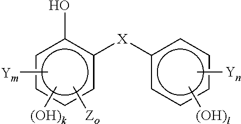
where
X=O, S or —CH2,
Y=Cl or Br,
Z=SO2H, NO2 or C1-C4-alkyl,
k, l=0 or 1,
m=0, 1, 2 or 3,
n=0, 1, 2 or 3,
o=0 or 1.

2. The composition according to claim 1, wherein the sugar surfactant is defined by the general formula (II)
R—O—Gₚ
where R=alkyl or alkenyl,
G=aldose or ketose and
P=1, 2, 3, 4, 5, 6, 7, 8, 9 or 10.

3. The composition according to claim 2, wherein R is a linear or branched carbon chain of C4-C22.

4. The composition according to claim 1, wherein the biocide is a compound of the formula (Ia) 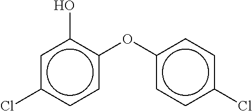
or the formula (Ib):

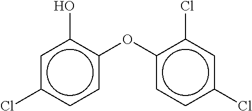

5. The composition according to claim 2, wherein the sugar surfactant is a mixtures of different compounds of the general formula (II) and the biocide is a mixtures of different compounds of the general formula (I).

6. The composition according to claim 1, wherein the composition is a cleaning composition for hard surfaces.

7. The composition according to claim 1, wherein the composition has a -pH between 5 and 12.

8. The composition according to claim 1, wherein the composition is in the form of a concentrate.

9. The composition according to claim 1, wherein, the cleaning composition contains the compound of the formula (I) and the compound of formula (I) has an end concentration of from 0.0001 to 10%.

10. The composition according to claim 1, wherein the cleaning composition contains, the compound of the formula (II) and the compound of formula (I) has an end concentration of from 0.1 to 20%.

11. The composition according to claim 1, comprising at least one further additive selected from the group consisting of: stabilizers, antioxidants, further surfactants, hydrotropic agents, consistency regulators, preservatives, fragrances, dyes, complexing agents, solvents and water.

12. A process for producing an antimicrobial cleaning composition according to claim 1, wherein the biocide of the formula (I) is pre-dissolved in the sugar surfactant and is then brought into an aqueous phase.

13. A method of increasing the detergency of a nonionic sugar surfactant by adding thereto a biocide of the formula (I) 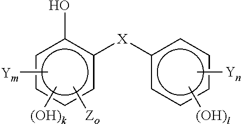
where
X=O, S or —CH2—,
Y=Cl or Br,
Z=SO2H, NO2 or C1C4-alkyl,
k, l=0 or 1,
m=0, 1, 2 or 3,
n=0, 1, 2 or 3,
o=0 or 1.

14. A method for increasing the antimicrobial effect of the biocide of the formula (I) 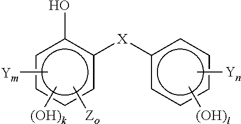
where
X=O, S or —CH2—,
Y=Cl or Br,
Z =SO2H, NO2 or C1-C4-alkyl,
k, l=0 or 1,
m=0, 1, 2 or 3,
n=0, 1, 2 or 3,
o=0 or 1
by adding thereto a sugar surfactant.

15. A method of cleaning and/or disinfection of hard surfaces by treating the surface with the composition according claim 1.
